(19) United States
(12) Patent Application Publication
(10) Pub. No.: US 2008/0228646 A1
(43) Pub. Date: Sep. 18, 2008

(54) METHOD AND SYSTEM FOR MANAGING A NON-CHANGING PAYMENT CARD ACCOUNT NUMBER

(76) Inventors: James R. Myers, St. Peters, MO (US); Beverly Y. Burbridge, St. Louis, MO (US); Michael S. Ameiss, O'Fallon, MO (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/866,357

(22) Filed: Oct. 2, 2007

Related U.S. Application Data
(60) Provisional application No. 60/828,202, filed on Oct. 4, 2006.

(51) Int. Cl. G06Q 40/00

(52) U.S. Cl. 705/41

(57) ABSTRACT

The present invention provides a method and system for managing a cardholder's payment card account having a non-changing account number associated with a payment card, the method comprising the steps of assigning a series of dynamic attributes to an account number, identifying the payment card account, and changing the dynamic attributes of the account number without changing the account number.

### CROSS-REFERENCE TO RELATED APPLICATIONS

This application claims priority from U.S. Provisional Application No. 60/828,202 filed Oct. 4, 2007, which is hereby incorporated herein by reference in its entirety.

### FIELD OF THE INVENTION

The invention broadly relates to payment cards and more particularly to a method and system for managing a cardholder's payment card account having a non-changing account number associated with the cardholder's payment card.

### BACKGROUND OF THE INVENTION

Payment cards, such as credit, debit cards, membership cards, promotional cards, frequent flyer cards, and identification cards, are widely used throughout the world. Such payment cards may include a variety of different indicia to identify the card, the individual using the card, a transaction account (e.g., a payment card account), and other features. The indicia may include a string of alphanumeric characters, a bar code or an encoded magnetic strip attached to the card. Payment cards related to financial transactions have a magnetic stripe which runs longitudinally across the face of one side and have a plurality of numbers, expiration date and a name embossed thereon.

Some payment card systems permit account numbers to be handled at an account number level rather than at an aggregated level for the limited purpose of interchange assessment, wherein account numbers are managed by the use of a look-up table and the attachment of a tag instructing interchange qualification. Other payment card systems employ tags that indicate enrollment of an account in a specific program, wherein the tags do not play a roll in the processes of authorization, clearing and settlement (e.g., as executed through authorization systems and clearing and management systems). These conventional payment card systems do not provide the ability to issue or maintain a single account number to a consumer account despite parameter changes made to the account, such as pricing changes, feature changes, service changes, changes in the name of a portfolio, and other parameter changes. To accommodate any of these parameter changes, a typical payment card system requires that a new or different account number be established.

### SUMMARY OF THE INVENTION

The present invention is directed to a method and system for managing a non-changing payment card account number that provides an ability to issue or maintain a single account number to a consumer account despite any parameter changes made to the account. Such parameter changes may include, but are not limited to: (1) pricing changes; (2) feature changes; (3) service changes; (4) changes in the name of a portfolio; and (5) other parameter changes.

The invention is further directed to a method and system for managing a non-changing payment card account number, the system and method providing a payment card network capable of executing all processing, data capture, data storage, and all associated ancillary activities at a single account number level.

Additionally, the invention provides a method and system for managing a non-changing payment card account number that encompass the global support of account level processing and management of associated services regardless of additional processing relationships.

One embodiment of the present invention involves a method and system for managing a cardholder's payment card account having a non-changing account number associated with a payment card, the method comprising the steps of assigning a series of dynamic attributes to an account number, identifying the payment card account, and changing the dynamic attributes of the account number without changing the account number. In a preferred implementation of the invention, the account number has 16 digits and the step of identifying the payment card account involves analyzing all 16 digits of the account number as opposed to only a portion of the account number such as the BIN.

According to some embodiments of the invention, the method further comprises the step of managing the flow of processing activities based on the dynamic attributes of the account number instead of managing the flow of processing activities based on the digits of the account number. The step of changing the dynamic attributes of the account number may include changing one or more parameter selected from the group consisting of pricing changes, feature changes, service changes, or changes in the name of a portfolio. These parameter changes may comprise new product information in the form of an account category code or a product code. The method may further comprise the step of providing a new payment card to the cardholder including the dynamic parameter changes, wherein the new payment card includes the same account number as the cardholder's original payment card.

In accordance with the principles of the invention, the method may be implemented using a payment card system including an authorization system, a clearing system, and a database. The payment card system is configured to execute all processing, data capture, and data storage at a single account number level. Additionally, the payment card system is configured to assign specific attributes to an account, and manage the flow of processing activities based on the assigned attributes rather than on the account number. The method may further comprise the step of updating the database of the payment card system.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIGS. 1A-1C illustrate a preferred payment card system and method for managing a cardholder's payment card account having a non-changing account number associated with a payment card, in accordance with the principles of the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

The present invention is directed to a method and system for managing a non-changing payment card account number that provides the ability to issue or maintain a single account number to a consumer payment card account regardless of parameter changes made to the payment card account with respect to pricing, features, services, name of portfolio, and other parameters changes. According to one implementation of the invention, the method and system encompass the global support of account level processing and management of associated services, regardless of additional processing relationships. This configuration allows greater and more dynamic processing options than banks that employ internal tags.

The invention further provides a payment card network capable of executing all processing, data capture, data storage, and all associated ancillary activities at a single account number level. In particular, the payment card network is capable of managing a series of dynamic attributes assigned to a single account number, permitting the use of the account number indefinitely, regardless of changes to the attributes assigned to the payment card account. In this regard, the network accommodates changes to a payment card account, without a systems based requirement that the account number be changed. The network is capable of assigning specific attributes to an account and managing the flow of processing activities based on those attributes rather than being part of the payment card account number itself.

The ability to manage or process the activities of a given payment card account number based on attributes assigned to the account number rather than a full 16 digit account number diverges from conventional practices, which characteristically rely on a one or two-tier aggregation of account numbers to guide various processing activities. Such tiers of aggregation are account number components comprising a portion of the payment card account number. Specifically, the BIN (Bank Identification Number) refers to the first six positions of the account number from left to right, whereas the account range typically refers to the BIN and a variable number of additional positions of the account number from left to right. A wide range of processing activities are currently directed based upon the BIN and/or the account range. Such aggregated processing makes it impossible for an account to change in a way that moves it from one aggregated population of accounts to another.

In accordance with the principles of the invention, by using attributes assigned to the full 16 digit account number as the identifier for processing activities (rather than the BIN, account range or other component of the account number), a single account number is configured to be transportable across all currently aggregated groups. In this manner, a single account number can be provided to an end consumer, wherein the account number never needs to be changed, regardless of any changes the end consumer or issuing bank may choose to make to the associated account or accounts.

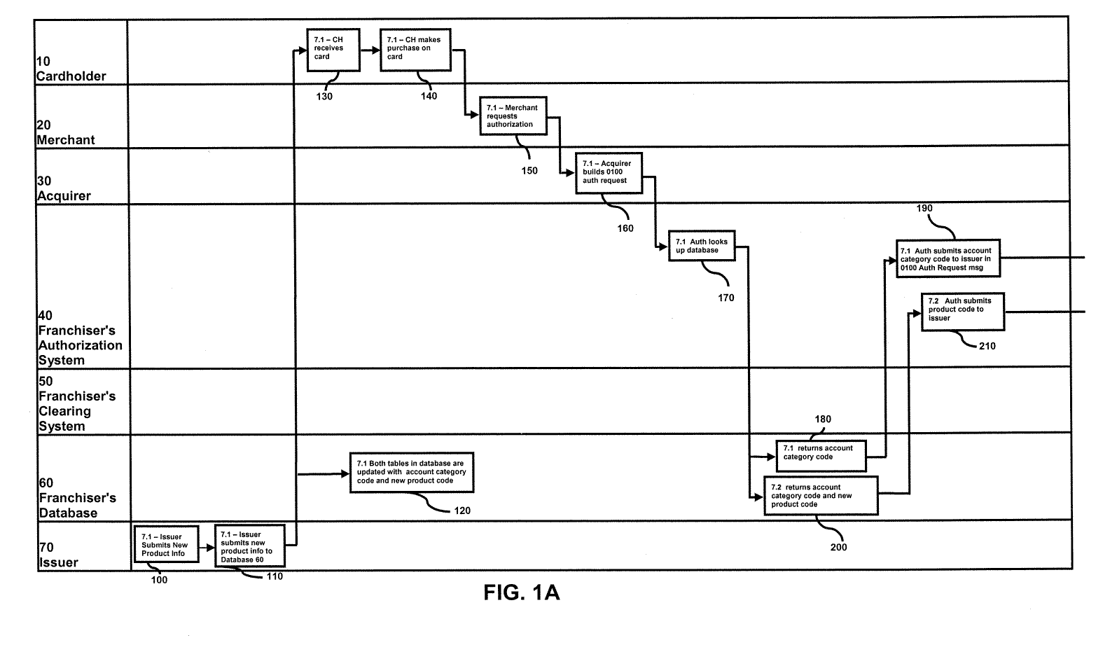

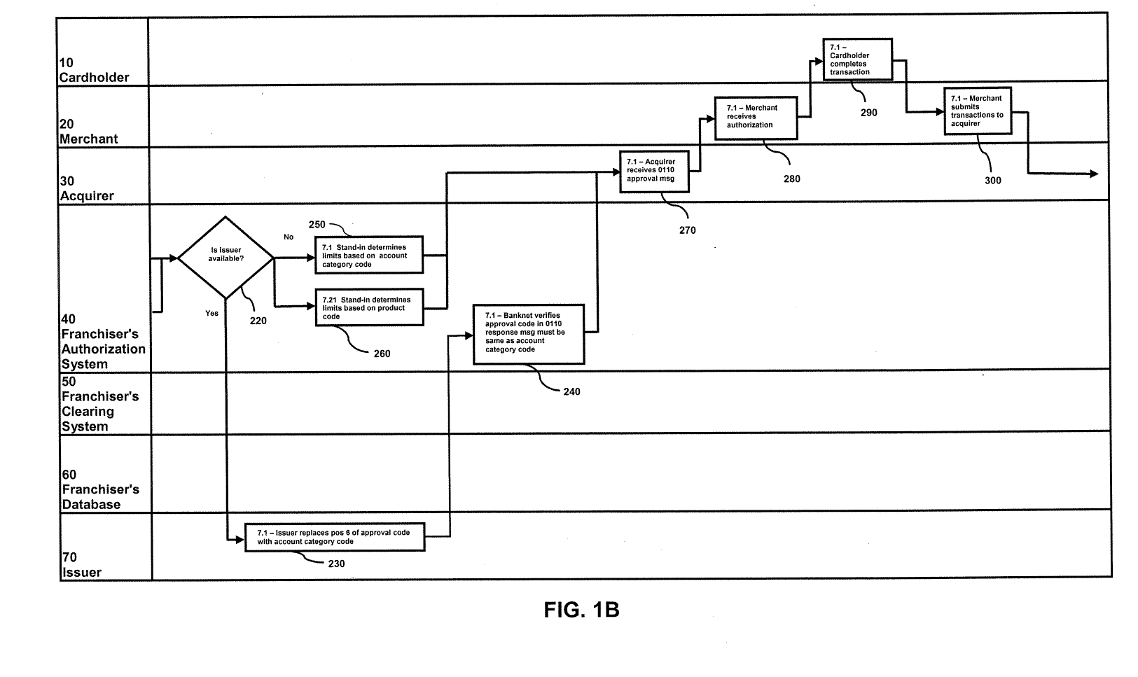

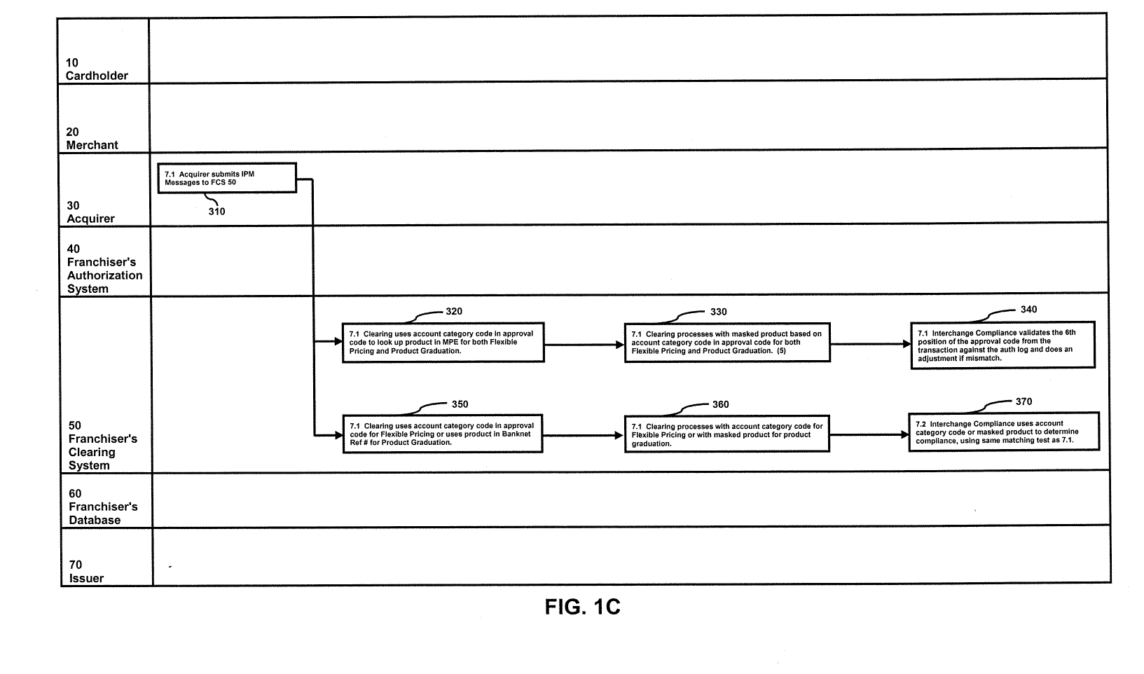

FIGS. 1A-1C illustrate a preferred payment card system and method for providing a payment card network for managing a non-changing payment account number, in accordance with the principles of the present invention. In particular, FIGS. 1-3 depict the process flow of information according to the method of the invention among a cardholder 10, a merchant 20, an acquirer 30, an issuer 70, and a franchiser 40, 50, 60. The franchiser 40, 50, 60 includes franchiser's authorization system 40, franchiser's clearing system 50, and franchiser's database 60. The payment card system is preferably implemented using one or more computer software applications comprising machine readable or interpretable instructions for providing account level management of information and the ability to issue or maintain a single account number to a cardholder account despite parameter changes made to the account.

According to an exemplary method of the invention, a series of dynamic attributes are assigned to a single account number that does not change despite any number of changes to the dynamic attributes. Payment card account numbers are analyzed using all 16 digits of the account number to identify the account as opposed to only a portion of the account number (e.g., only using the BIN). In this manner, the flow of processing activities is managed based on the assigned attributes rather than on the account number itself.

With reference to FIG. 1A, in process step 100, the issuer 70 changes one or more parameters of an existing account of cardholder 10, for example in response to a request by the cardholder. Such parameter changes may include without limitation, pricing changes, feature changes, service changes, changes in the name of a portfolio, and/or other parameter changes. In process step 110, the issuer 70 submits the new product information including the parameter changes to the franchiser's database 60. The new product information submitted to the franchiser's database may be provided in the form of account category code, product code, new product code, and/or date. In process step 120, the franchiser's database 60 is updated with the account category code and the new product code. Additionally, the MIP is updated with information (e.g., whether issuer BIN range is participating). Process step 130 involves the cardholder receiving a new payment card including the specified parameter changes, but having the same account number as the cardholder's original payment card. In process step 140, the cardholder 10 makes a purchase using the payment card.

With further reference to FIG. 1A, process step 150 involves the merchant 20 requesting authorization from the acquirer 30, while process step 160 involves the acquirer 30 building an authorization request for the purchase and submitting the request to the franchiser's authorization system 40. In process step 170, the franchiser's authorization system 40 requests information from the franchiser's database 60. Process step 180 involves the franchiser's database 60 sending the account category code to the franchiser's authorization system 40, whereas process step 190 involves the franchiser's authorization system 40 submitting the account category code to the issuer 70 in an authorization request message. In accordance with an alternative embodiment of the invention, the method may proceed from process step 170 to process step 200, which involves the franchiser's database 60 sending the account category code and new product code (e.g., in a Banknet Reference Number) to the franchiser's authorization system 40, which submits the product code to the issuer 70 in the Banknet Reference Number (process step 210). In process steps 170-200, the MIP recognizes issuer account range is a participant and performs the database lookup, the database 60 finds (or does not find) the account and enriches the authentication request message with the account category code, and then the franchiser's authorization system 40 forwards the enriched authentication request message to the issuer 70 or stand-in (process step 210). Process step 200 also involves the creation of the Banknet Reference Number with the new product code.

Referring to FIG. 1B, process step 220 involves a determination by the franchiser's authorization system 40 whether the issuer 70 is available. If the issuer 70 is available, the method proceeds to process step 230, which involves the issuer 70 replacing the approval code or a portion of the approval code (e.g., position 6) with the account category code and sending the approval code to the authorization system 40. In process step 240, the franchiser's authorization system 40 verifies that the approval code in the authentication response message is the same as the account category code and forwards the approval message to the acquirer 30. If in process step 220 it is determined that the issuer 70 is unavailable, the method proceeds to process step 250, which involves the stand-in determining limits based on the account category code and sending the approval message to the acquirer 30.

With further reference to FIG. 1B, in accordance with the alternative embodiment, the method proceeds from process step 220 to process step 260, which involves the stand-in determining limits based on the product code in the Banknet Reference Number and sending the approval message to the acquirer 30. Process step 270 involves the acquirer receiving the approval message and sending authorization to the merchant 20. Process step 280 involves the merchant 20 receiving the authorization an allowing the cardholder 10 to complete the transaction. In process step 290, the cardholder 10 completes the transaction, and then the merchant 20 submits the transaction to the acquirer 30 in process step 300.

Referring to FIG. 1C, process step 310 involves the acquirer 30 selecting an applicable interchange program based on the account category code and submits the interchange program messages to the franchiser's clearing system 50. Alternatively, process step 310 may involve the acquirer 30 selecting an applicable interchange program based on the account category code in the approval code for flexible pricing or for product graduation. In process step 320, the clearing system 50 uses the account category code in the approval code to look up the product for both flexible pricing and product graduation. In process step 330, the clearing system 50 processes with masked product based on the account category code in the approval code for both flexible pricing and product graduation. In process step 340, interchange compliance validates the approval code or portion of the approval code (e.g., 6^{th} position) for the transaction against the authentication log and performs an appropriate adjustment is there is a mismatch.

With further reference to FIG. 1C, according to the alternative embodiment, after the acquirer 30 submits the interchange program messages to the franchiser's clearing system (process step 310), the method proceeds to process step 350, wherein the clearing system 50 uses the account category code in the approval code for flexible pricing or uses the product in the Banknet Reference Number for product graduation. In process step 360, the clearing system 50 processes with the account category code for flexible pricing or with masked product for product graduation. In process step 370, interchange compliance uses the account category code or masked product to determine compliance by validating the approval code or portion of the approval code (e.g., 6^{th} position) for the transaction against the authentication log and performs an appropriate adjustment is there is a mismatch.

As set forth hereinabove, the payment card system of the invention provides a payment card network with the ability to issue or maintain a single account number to a consumer account despite parameter changes made to the account. The payment card network is capable of executing all processing, data capture, data storage, and all associated ancillary activities at a single account number level. In this manner, the payment card system is capable of managing a series of dynamic attributes assigned to a single account number, and permitting the use of the account number regardless of changes to the attributes assigned to the account. This capability accommodates changes to a payment card account with no systems based requirement that the account number be changed. By contrast, convention systems are not capable of accommodating such changes without requiring, at a minimum, a new or different account number.

The system and method described herein involve an analysis of payment card account numbers using all 16 digits of the account number to identify the account, as opposed to using only a portion of the account number (e.g., only using the BIN). The system is configured to assign specific attributes to an account, and manage the flow of processing activities based on the assigned attributes rather than on the account number itself. This ability to manage and process the activities of an account number based on attributes assigned to the account number (rather than on the account number itself) is more dynamic than existing payment card systems that rely on a one-tier or two-tier aggregation of account numbers (e.g., the BIN and the account range) to guide processing activities. By nature, this type of processing occurs at an aggregated level that makes it infeasible to move an account from one aggregated population of accounts to another aggregated population of accounts.

By using attributes assigned to a full 16 digit account number as the identifier for processing activities rather than a component of the account number such as the BIN or account range, the payment card system and method of the invention provide account numbers that are transportable across all currently aggregated groups. According to the invention, a cardholder is provided with a single account number that does not need to be changed despite parameter changes that the cardholder or issuing bank makes to the associated account. These parameter changes may include pricing changes, feature changes, service changes, changes in the name of a portfolio, and/or other parameter changes.

Thus, it is seen that a method and system for managing a non-changing payment card account number is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for managing a cardholder's payment card account having a non-changing account number associated with a payment card, the method comprising the steps of:
assigning a series of dynamic attributes to an account number;
identifying the payment card account; and
changing the dynamic attributes of the account number without changing the account number.

2. The method of claim 1, wherein:
the account number has 16 digits; and
the step of identifying the payment card account comprises analyzing all 16 digits of the account number.

3. The method of claim 1, further comprising the step of managing a flow of processing activities based on the dynamic attributes of the account number instead of managing the flow of processing activities based on the digits of the account number.

4. The method of claim 1, wherein the step of changing the dynamic attributes of the account number involves changing one or more parameter selected from the group consisting of pricing changes, feature changes, service changes, or changes in the name of a portfolio.

5. The method of claim 4, wherein the parameter changes comprise new product information in the form of an account category code or a product code.

6. The method of claim 1, further comprising the step of providing a new payment card to the cardholder including the dynamic parameter changes.

7. The method of claim 6, wherein the new payment card includes the same account number as the cardholder's original payment card.

8. The method of claim 1, wherein the method is implemented using a payment card system including an authorization system, a clearing system, and a database.

9. The method of claim 8, further comprising the step of updating the database of the payment card system.

10. The method of claim 8, wherein the payment card system is configured to execute all processing, data capture, and data storage at a single account number level.

11. A method for managing a cardholder's payment card account having a non-changing account number associated with a payment card, the method comprising the steps of:
assigning a series of dynamic attributes to an account number having 16 digits;
identifying the payment card account by analyzing all 16 digits of the account number;
managing a flow of processing activities based on the dynamic attributes of the account number; and
changing the dynamic attributes of the account number without changing the account number.

12. The method of claim 11, further comprising the step of providing a new payment card to the cardholder including the dynamic attribute changes.

13. The method of claim 11, wherein the method is implemented using a payment card system including an authorization system, a clearing system, and a database.

14. The method of claim 13, further comprising the step of updating the database of the payment card system.

15. The method of claim 13, wherein the payment card system is configured to execute all processing, data capture, and data storage at a single account number level.

16. The method of claim 11, wherein the step of changing the dynamic attributes of the account number involves changing one or more parameter selected from the group consisting of pricing changes, feature changes, service changes, or changes in the name of a portfolio.

17. The method of claim 16, wherein the parameter changes comprise new product information in the form of an account category code or a product code.

18. A method for managing a cardholder's payment card account having a non-changing account number associated with a payment card, wherein the method is implemented using a payment card system including an authorization system, a clearing system, and a database, the method comprising the steps of:
assigning a series of dynamic attributes to an account number having 16 digits;
identifying the payment card account by analyzing all 16 digits of the account number;
managing a flow of processing activities based on the dynamic attributes of the account number;
changing the dynamic attributes of the account number without changing the account number; and
updating the database of the payment card system.

19. The method of claim 18, further comprising the step of providing a new payment card to the cardholder including the dynamic parameter changes

20. The method of claim 18, wherein the payment card system is configured to execute all processing, data capture, and data storage at a single account number level.

21. The method of claim 18, wherein the step of changing the dynamic attributes of the account number involves changing one or more parameter selected from the group consisting of pricing changes, feature changes, service changes, or changes in the name of a portfolio.

22. The method of claim 21, wherein the parameter changes comprise new product information in the form of an account category code or a product code.
